(19) United States
(12) Patent Application Publication
(10) Pub. No.: US 2024/0269678 A1
(43) Pub. Date: Aug. 15, 2024

(54) TRANSFER DISPENSERS FOR ASSAY DEVICES WITH BEAD SIZE EXCLUSION

(71) Applicant: Plexium, Inc., San Diego, CA (US)

(72) Inventors: Edgar GUTIERREZ, San Diego, CA (US); Jesse LU, San Diego, CA (US); Kapil MAHAKALKAR, San Diego, CA (US); Galen HAMMERLE, San Diego, CA (US); Yi ZHANG, San Diego, CA (US)

(21) Appl. No.: 18/567,688

(22) PCT Filed: Jun. 7, 2022
(86) PCT No.: PCT/US2022/032559

§ 371 Date: Dec. 6, 2023

Related U.S. Application Data
(60) Provisional application No. 63/273,389, filed on Oct. 29, 2021.
(60) Provisional application No. 63/197,972, filed on Jun. 7, 2021.

(51) Int. Cl. B01L 3/00

(52) U.S. Cl. CPC B01L 3/52; B01L 2200/0647; B01L 2300/0829

(57) ABSTRACT

Disclosed are transfer dispensers for assay devices. These dispensers provide for transfer of a single assay component into a single well in the assay device. This ensures that the assay conducted in each well contains only a single component. These dispensers each include shafts, wherein each of the shafts has a variable cross-sectional width and releasably contains a single assay component having a width larger than a minimum cross-sectional width within a corresponding shaft. Each dispenser is fitted onto or over an assay device such that each shaft is aligned with a single well on the assay device such that upon release of the single assay component from said dispenser, only the single assay component is deposited into a single well.

This application claims priority to United States Provisional Application Nos. 63/197,972, filed Jun. 7, 2021 and 63/273,389, filed Oct. 29, 2021, which is hereby incorporated by reference in their entirety.

### FIELD

This disclosure describes transfer dispensers for assay devices. These dispensers provide for transfer of a single assay component into a single well in the assay device per use. This ensures that the assay conducted in each well contains only a single unit of that component when the presence of such a single unit is necessary for the assay that is to be conducted.

### STATE OF THE ART

Combinatorial libraries are well known in the literature and often utilize beads, where each bead contains multiple copies of a single compound bound by a linker to the bead. In addition, the bead typically contains a reporting element such as DNA that allows for assessing the structure of the single compound on the bead. Many of these libraries are limited by the fact that the compound being tested remains on the bead during the assay. As such, the biological data generated by the assay is potentially compromised by the possibility that the bound compound is not able to effectively bind to the target of choice. This could be due to physical interference arising from the bead as well as possible steric interference due to the attachment of a linker connecting the compound to a bead. As to the latter, this linkage could inhibit the ability of an otherwise potent compound from binding properly to the target thereby providing assay results that evidence less than the actual potency of the compound. Moreover, when the target is a cell and penetration of the compound into the cell is required as part of the assay, compounds remaining bound to the bead are unlikely to penetrate into the cell.

One option for addressing this problem includes the use of cleavable linkers that cleave under proper stimulation (e.g., light) thereby freeing the compound from the bead. Once the compound is in solution, such as in a test well, it is free to orient itself in a manner that provides maximum potency in the assay. Still further, release of these compounds can be conducted in a manner such that the amount of compound released is controlled so as to provide meaningful dose dependent data. See, e.g., U.S. Patent Application Pub. No. 2019/0358629, now U.S. Pat. No. 10,828,643, each of which is incorporated herein by reference in its entirety.

In a typical combinatorial library, thousands of beads are used where each bead contains multiple copies of the same test compound. Such beads can be made by the well-known split/pool synthetic processes. In one case, the identity of the compound on the bead is recorded by a reporter molecule such as DNA. In another case, the identity of each reaction step conducted on each bead is recorded by the addition of a DNA segment corresponding to that step thereby generating a unique strand of DNA for each compound. Typically, each well comprises a single bead as well as other assay components such as a single mammalian cell. If a given well in the assay device provides for a positive “hit” (an active compound), the DNA is recovered, amplified and then sequenced. The resulting sequence is the aggregate of the specific reaction steps used to synthesize that compound thereby allowing the synthetic chemist to ascertain the structure of the active compound.

In order to increase the amount of information generated by an assay, one option is to increase the number of wells in the assay device (e.g., a high throughput device). In general, assay devices that contain ten thousand or more to millions of wells will provide more information as to what structures provide activity against a given target as opposed to assay devices that contain tens to hundreds of wells.

Moreover, in order to accommodate an aqueous solution and other assay components, the well size must be much larger than the assay components such as a bead. This makes adding only a single small bead to a single well a serious challenge. If by chance, two or more beads each containing different compounds are added to a single well, the ability to assess which compound is active (or if both are active) becomes problematic at best. When the assay device contains thousands to millions of individual wells, the ability to add just a single bead to each well is a huge challenge. Adding to that complication is how to add a single assay component to each well when the assay requires the addition of two different components (e.g., a single bead and a single cell in a single well).

Still further, commercially available beads do not have a uniform size. Rather, these beads typically have a Gaussian curve (bell shape curve) where the reported size of these beads is the average of that curve. This means that a population of beads reported as being 20 microns in diameter can have a subset of these beads with a diameter significantly less than 20 microns. Since the volume of a sphere is based on the formula 4/3piR³, a bead that has a radius that is 70% as large as the average radius will occupy only 34% of the space as the average sized bead. As such, there is a risk that two smaller beads can occupy the same cavity thereby limiting the value of the transfer device.

Heretofore, dispensers comprising a plurality of cavities have been described in U.S. Pat. No. 11,027,272B2, which is incorporated herein by reference in its entirety. That application recited that one method for obviating this problem was to size exclude smaller beads from the population of beads. Stated another way, one could truncate the Gaussian curve at a size where smaller beads were eliminated. Such could be done by, e.g., size exclusion techniques. However, this required further processing of the beads prior to use and, in some cases, rendering the smaller beads not suitable for use.

Accordingly, there is an ongoing need to provide dispensers for addition of a single assay component to a single well in a high throughput assay device.

### SUMMARY

One or more of the following features may be included in any feasible combination.

In one embodiment, there is provided a dispenser 1 that comprises a top surface 2 and a bottom surface 3 as well as a plurality of shafts 4 that extends through dispenser 1 such that each of shafts 4 has a top or first opening (hereinafter “first opening”) 5 and a second opening 6 which may be smaller compared to the first opening 5. In some embodiments, the second opening 6 may be preferably located at or near the bottom of dispenser 1. However, as illustrated in FIGS. 5-7 and 11-12, the second opening 6 may also be located away from an extremity (e.g., bottom) of the dispenser 1 or the shaft 4, and may be in an interior of the shaft 4. The first opening 5 is configured to allow assay components to position into or onto said shaft 4 whereas the second opening 6 of shaft 4 is configured to allow smaller assay components with a predetermined diameter or less to pass through said shaft 4 and out of dispenser 1. As designed, shafts 4 will reversibly, releasably, or transposably hold/capture only a single assay component, such as a bead 11, as smaller assay components will pass through shafts 4 and larger assay components having a width or diameter that exceeds a width or diameter of the shafts 4 will not fit onto or in said shaft 4.

In one embodiment, dispenser 1 is configured to fit or mate with an assay device 20 comprising a multiplicity of wells 21 such that, when fitted, each shaft 4 in said dispenser 1 is aligned with a single well 21 in said assay device 20. Upon release, assay components move from dispenser 1 into assay device 20 such that a single assay component is deposited into a single well 21.

In one embodiment, shafts 4 in dispenser 1 are configured to retain only a single assay component, which can be a bead 11 which comprises a multiplicity of the same compound reversibly linked thereto by a cleavable linker and optionally a DNA reporter that records either the structure of the test compound bound thereto or the synthetic steps used to create the test compound.

In one embodiment, assay component 10 comprises a mammalian cell such as a human cell which is integral to the assay to be conducted.

In one embodiment, a system for dispensing beads (e.g., 11) into an assay device (e.g., 20) comprises an assay device comprising a multiplicity of wells (e.g., 21) and a dispenser (e.g., 1) comprising a multiplicity of shafts (e.g., 4). Each of said shafts comprises a variable cross-sectional width, and releasably contains a single assay component having a width larger than a minimum cross-sectional width within a corresponding shaft. The dispenser is fitted onto or over said assay device such that each shaft is aligned with a single well on said assay device such that upon release of said single assay component from said dispenser, only the single assay component is deposited into a single well.

In one embodiment, a first shaft of said shafts comprises a contour of a frustum or an hourglass.

In one embodiment, a first shaft of said shafts comprises a circular cross-section, and the cross-sectional width of the first shaft is indicative of a diameter of the circular cross-section.

In one embodiment, a first shaft of the shafts comprises a first portion at which a width decreases with respect to a height of the first shaft and a second portion at which a width increases with respect to a height of the first shaft.

In one embodiment, a first shaft of the shafts comprises a first portion having a first width and a second portion having a second width.

In one embodiment, a first shaft of said shafts comprises a portion in which a cross-sectional width decreases at a decreasing rate with respect to a height of the first shaft.

In one embodiment, a first shaft of said shafts comprises a portion in which a cross-sectional width decreases at an increasing rate with respect to a height of the first shaft.

In one embodiment, the system further comprises a channel (e.g., 17) disposed underneath the shafts, the channel having a height of at least the minimum cross-sectional widths of the shafts. The channel is configured to collect one or more second assay components that have second widths smaller than the minimum cross-sectional widths of the corresponding shafts through which the assay components pass, and divert the second assay components to a second dispenser comprising a multiplicity of second shafts.

In one embodiment, the system further comprises the second dispenser, wherein each of the second shafts comprises a second variable cross-sectional width, wherein a second minimum cross-sectional width of each of the second shafts is less than the minimum cross-sectional widths of the shafts. Each of the second shafts releasably contains a single second assay component having a second width larger than the second minimum cross-sectional width within a corresponding second shaft.

In one embodiment, the dispenser comprises an outlet through which one or more third assay components are diverted, the third assay components having third widths exceeding opening widths at openings of the corresponding shafts.

In one embodiment, the single assay component comprises a bead or a cell.

In one embodiment, a dispenser comprises a multiplicity of shafts. Each of said shafts comprises a variable cross-sectional width and releasably contains a single assay component having a width larger than a minimum cross-sectional width within a corresponding shaft. Said dispenser is fitted onto or over said assay device such that each shaft is aligned with a single well on said assay device such that upon release of said single assay component from said dispenser, only the single assay component is deposited into a single well.

In one embodiment, a first shaft of said shafts comprises a contour of a frustum or an hourglass.

In one embodiment, a first shaft of the shafts comprises a first portion at which a width decreases with respect to a height of the first shaft and a second portion at which a width increases with respect to a height of the first shaft.

In one embodiment, a first shaft of said shafts comprises a circular cross-section, and the cross-sectional width of the first shaft is indicative of a diameter of the circular cross-section.

In one embodiment, a first shaft of the shafts comprises a first portion having a first width and a second portion having a second width.

In one embodiment, a first shaft of said shafts comprises a portion in which a cross-sectional width decreases at a decreasing rate with respect to a height of the first shaft.

In one embodiment, the dispenser comprises a channel disposed underneath the shafts, the channel having a height of at least the minimum cross-sectional widths of the shafts. The channel is configured to collect one or more second assay components that have second widths smaller than the minimum cross-sectional widths of the corresponding shafts through which the assay components pass and divert the second assay components to a second dispenser comprising a multiplicity of second shafts.

In one embodiment, the dispenser comprises an outlet through which one or more third assay components are diverted, the third assay components having third widths exceeding opening widths at openings of the corresponding shafts.

In one embodiment, the single assay component comprises a bead or a cell.

These and other capabilities of the disclosed subject matter will be more fully understood after a review of the following figures, detailed description, and claims.

### BRIEF DESCRIPTION OF THE FIGURES

These and other features will be more readily understood from the following detailed description taken in conjunction with the accompanying drawings.

FIG. 1 illustrates a top view of dispenser 1 having a top surface 2 and a bottom surface 3 including shafts 4 running therethrough. One shaft 4 is shown in three-dimensions according to an exemplary embodiment.

FIG. 2A illustrates shaft 4 sized to fit a single assay component which for illustrative purposes is a substantially spherical bead 11 according to an exemplary embodiment.

FIG. 2B illustrates insertion of bead 11 into shaft 4 according to an exemplary embodiment. In this embodiment, bead 11 is lodged into shaft 4 at the point where the narrowing width or diameter of shaft 4 prevents bead 11 from further traversing through shaft 4.

FIG. 2C illustrates that partial insertion of bead 11 into shaft 4 is sufficient to capture bead 11 according to an exemplary embodiment.

FIG. 2D illustrates removal of a smaller bead 12 having a width or diameter smaller than the narrowest width or diameter of shaft 4. In this case, smaller bead 12 exits the second opening 6 at a bottom of shaft 4.

FIGS. 3A and 3B illustrate loading of assay component into an empty dispenser 1. FIG. 3A illustrates a containment cap 30 equipped with an inlet 31 and outlet 32 used in conjunction with a funnel-like cone 40 to deliver beads 11 into shafts 4 of dispenser 1 according to an exemplary embodiment.

FIG. 3B illustrates beads 11 delivered into shafts 4 of dispenser 1 according to an exemplary embodiment. Extra beads not within a shaft 4 exit containment cap 30 to recycle into a separate dispenser. For example, beads 11 that exceed a width of the first opening 5 may be directed, along a positive x-direction, through the outlet 32. From the separate dispenser, the extra beads may be analyzed and/or redirected into different sized shafts compared to the shafts 4.

FIGS. 3C and 3D illustrate diverting of smaller beads 12, which are not retained within the shafts 4, from the shafts 4 to a channel 17. The smaller beads 12 may be separately collected, and/or diverted into smaller shafts 54 which may retain some or all of the smaller beads 12. FIG. 3C illustrates a downwardly-sloping channel 17 through which the smaller beads are diverted.

FIG. 3D illustrates a level, flat-sloped channel 17 through which the smaller beads are diverted.

FIG. 3E illustrates a mechanism of size exclusion, using a control of opening and closing valves, to obtain beads having a particular range of widths in two stages, a first stage in which beads larger than a second threshold width are excluded or removed and a second stage in which beads smaller than a first threshold width are excluded or removed.

FIGS. 3F and 3G illustrate a mechanism of size exclusion to obtain beads having a particular range of widths in two stages, a first stage in which beads larger than a second threshold width are excluded or removed and a second stage in which beads smaller than a first threshold width are excluded or removed. Therefore, beads between the first threshold width and the second threshold width are obtained.

FIG. 4A illustrates integrating or fitting dispenser 1 with an assay device 20 to deliver beads 11 from shafts 4 to wells 21 of assay device 20. Alignment of dispenser 1 with assay device 20 can be facilitated with optional locking mechanism 23. When locked in place, dispenser 1 and assay device 20 need not be flush against each other. An optional gap 22 can be present, so long as gap 22 is smaller or narrower than a width of the bead 11 or other assay components according to an exemplary embodiment.

FIG. 4B illustrates the inversion of the setup in FIG. 4A and the delivery of beads 11 or other assay component from dispenser 1 into wells 21 of assay device 20 according to an exemplary embodiment.

FIGS. 5-12 and 13A-13D illustrate exemplary shafts 4 which have different profiles or contours. In FIGS. 5-7, the shafts 4 have different hourglass profiles or contours. FIG. 5 illustrates an alternative embodiment wherein the narrowest width or diameter of shaft 4 is internal to the shaft 4. In FIG. 5, a rate at which the width or diameter decreases is constant with respect to a height of the shaft 4.

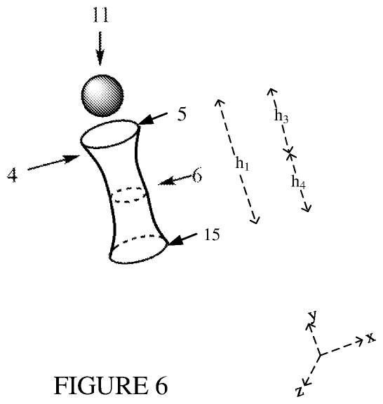

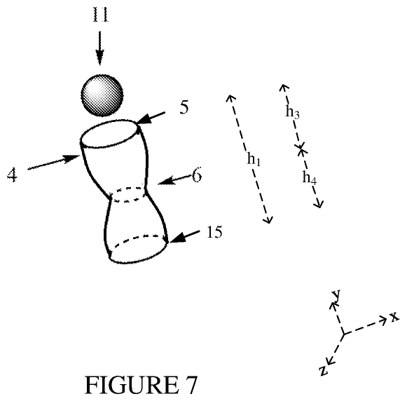

In FIGS. 6-7, likewise, the narrowest widths or diameters of the shafts 4 are not located at an extremity of the shaft. In FIG. 6, a rate at which the width or diameter decreases is decreasing with respect to a height of the shaft 4.

In FIG. 7, a rate at which the width or diameter decreases is increasing with respect to a height of the shaft 4.

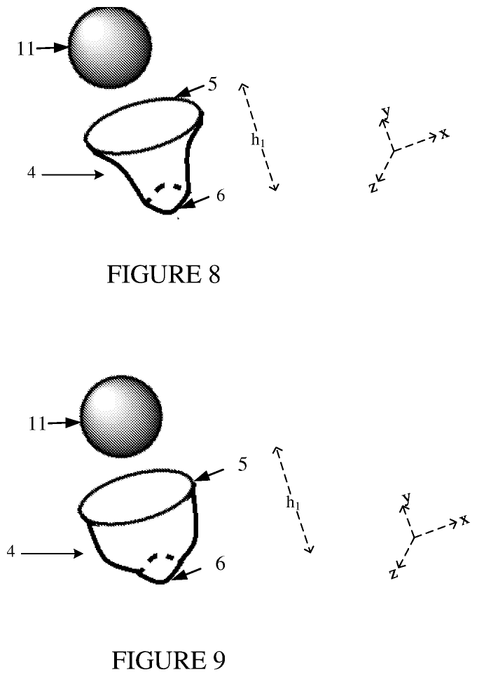

In FIG. 8, the shaft 4 has a concave profile or contour.

In FIG. 9, the shaft 4 has a convex profile or contour.

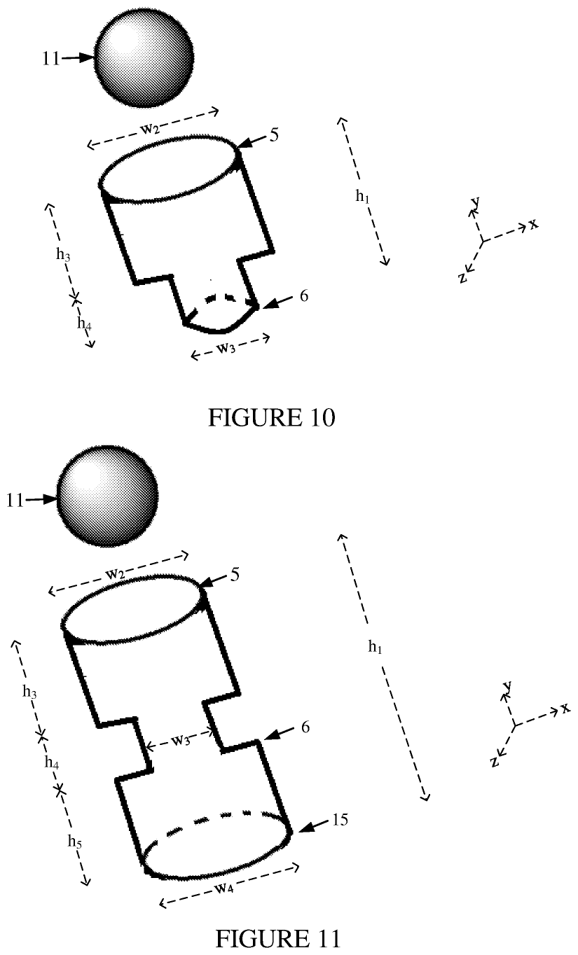

In FIGS. 10-11, the shafts 4 have different regions, portions, or sections, each of which has a constant or near-constant cross-sectional width. In FIG. 10, the shaft 4 is illustrated to include two different regions.

In FIG. 11, the shaft 4 is illustrated to include three different regions.

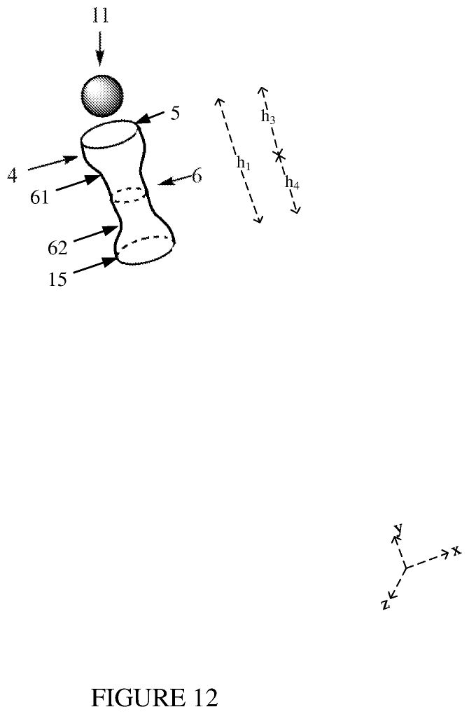

In FIG. 12, the shaft 4 has an hourglass profile or contour and has one or more inflection points.

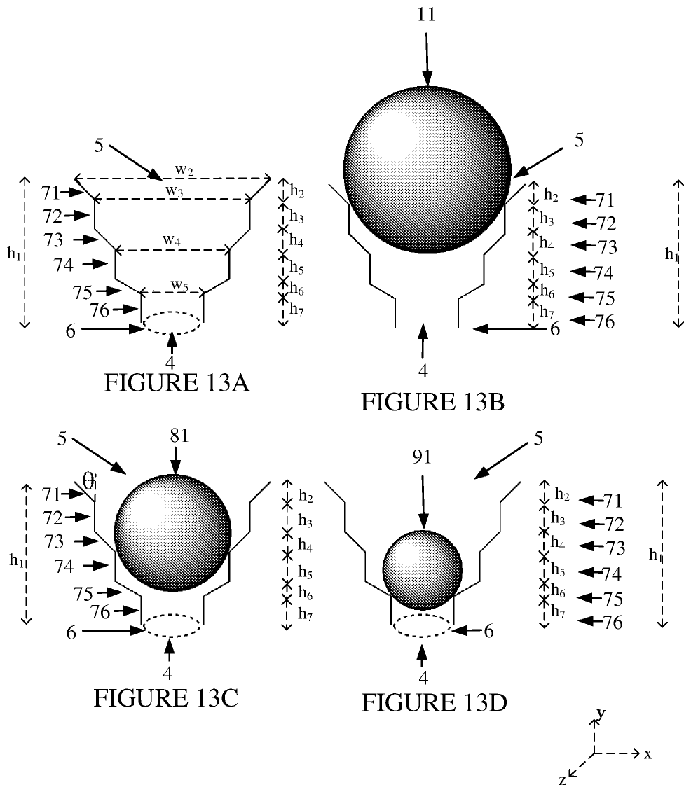

In FIG. 13A, the shaft 4 has a zigzag profile, which includes alternating regions of changing cross-sectional width and constant or near constant cross-sectional width.

In FIGS. 13B-13D, the shaft 4 of FIG. 13A is illustrated with different sized beads.

It is noted that the drawings are not necessarily to scale. The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

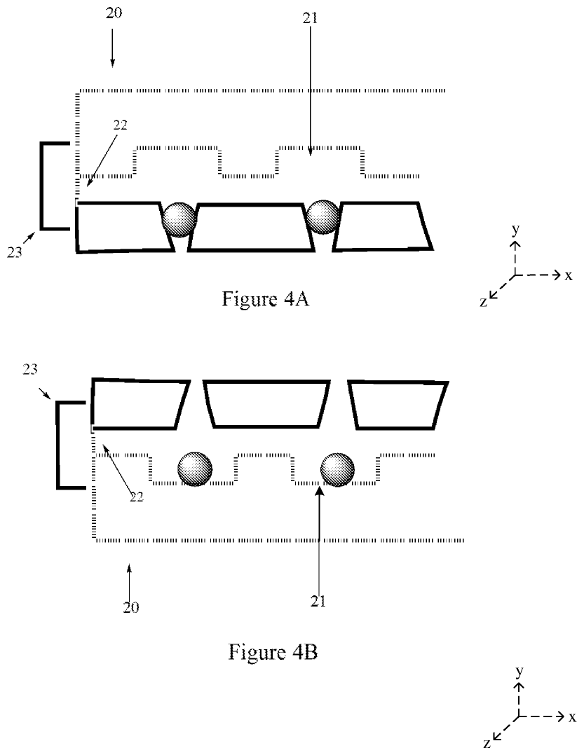

Disclosed are dispensers for loading assay components into an assay device 20, as illustrated in FIGS. 4A and 4B, capable of assaying library of test compounds generated by combinatorial chemistry techniques. However, prior to describing these embodiments in more detail, the following terms will first be defined. If not defined, terms used herein have their generally accepted Scientific meaning.

For ease of reference, the numerous apparatus and numbers used herein are summarized as follows:

### Dispensers

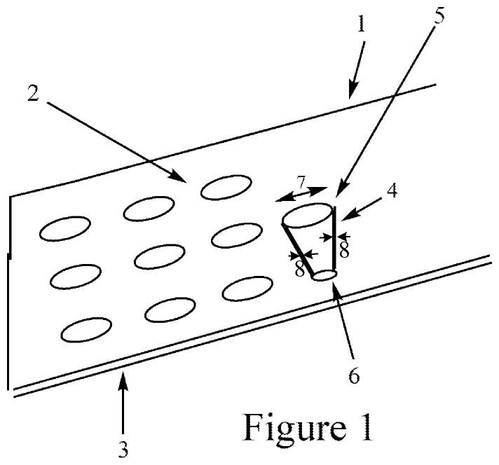

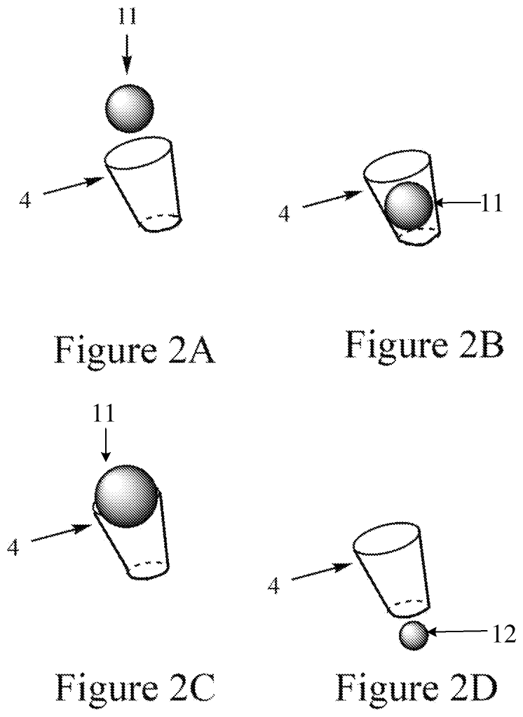

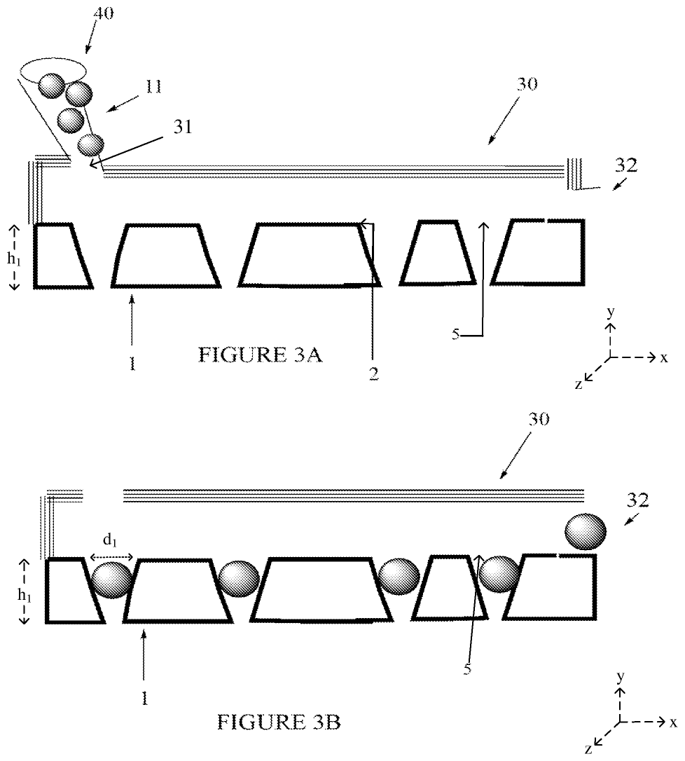

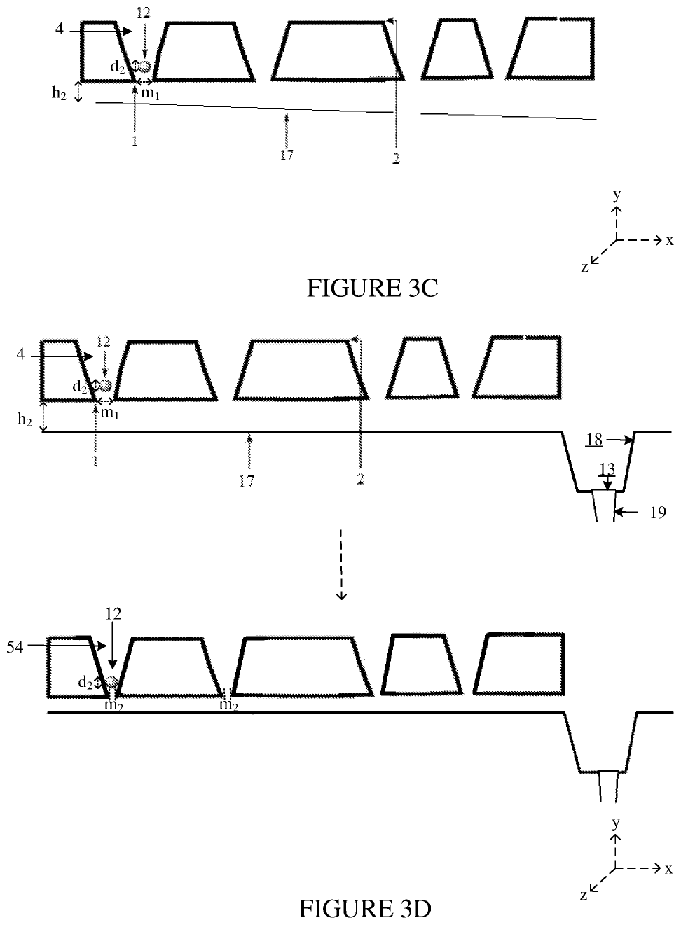

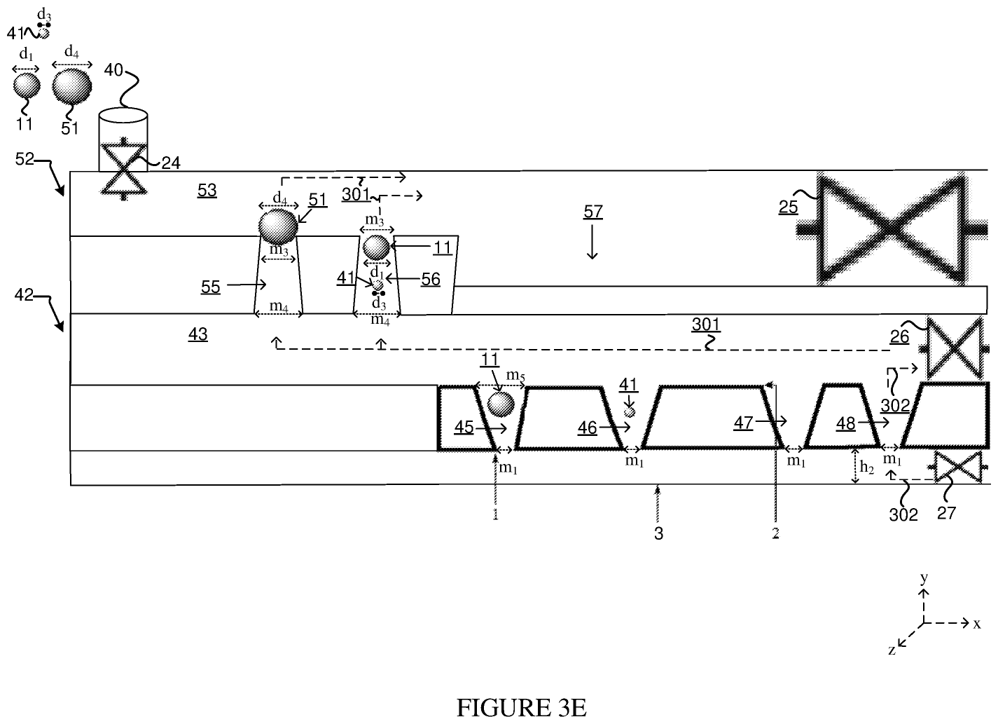

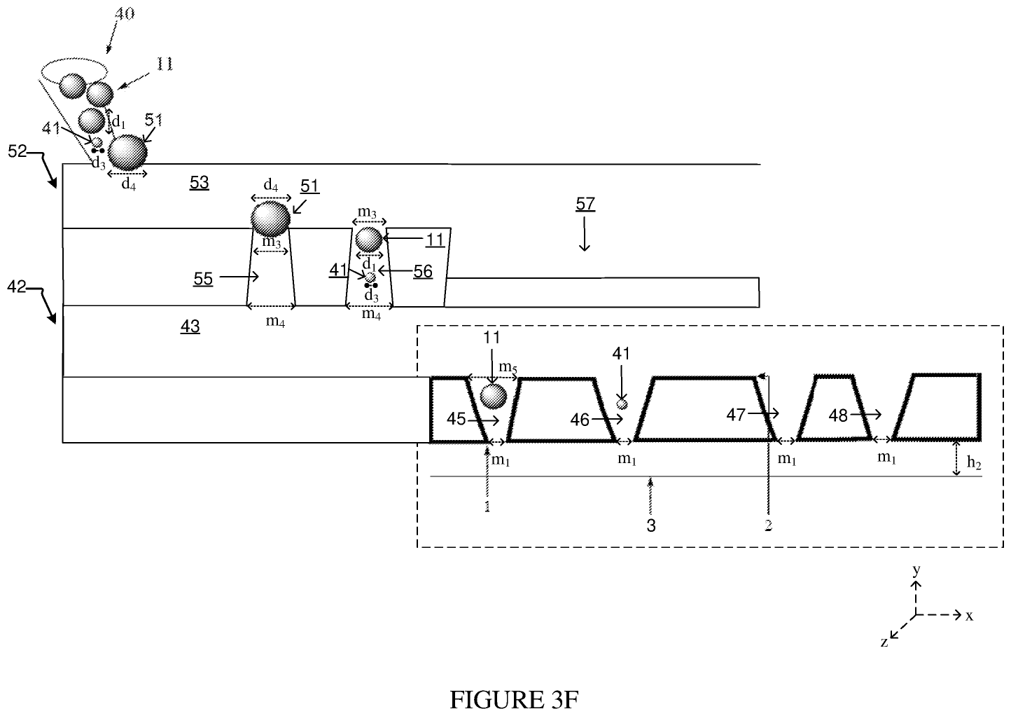

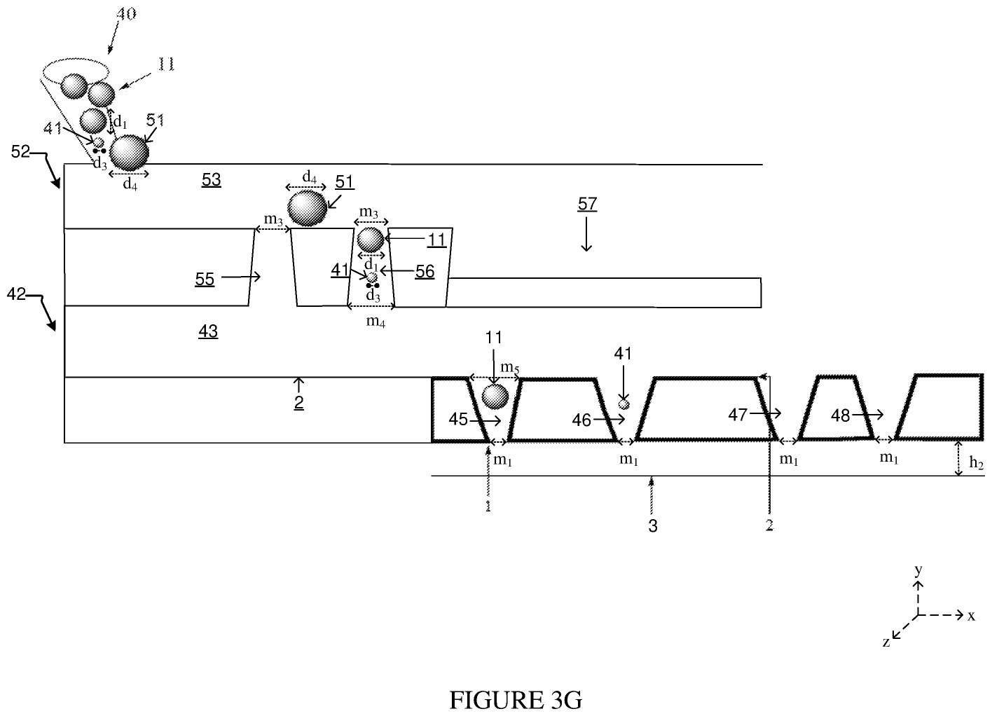

Dispenser 1—delivers assay components, such as bead(s) 11, as illustrated in FIGS. 2A, 2B, 2C, 2D, 3A, and 5, to assay device 20. Herein, reference may be made to bead(s) 11 either in singular or plural form. Dispenser 1 comprises a top surface 2, a bottom surface 3 and one or more shafts, channels, indentations, or cavities (hereinafter “shaft” or “shafts”) 4 that extend through dispenser 1. FIG. 1 shows an embodiment of dispenser 1 with one shaft 4 in expanded view. The shaft 4 may have a variable cross-sectional width or diameter (hereinafter “diameter”). In some examples or scenarios, the shaft 4 may have a circular cross section, and the cross-sectional width may refer to a diameter. In an example in which the shaft 4 has a circular cross section, a diameter 7 of shaft 4, as illustrated in FIG. 1, may be narrower at the second opening 6 as compared to the first opening 5. In the embodiment shown, the shape of the shaft 4 is substantially a truncated cone such that a bottom portion of the cone has been removed (drawings are not necessarily to scale). In FIGS. 3A-3B, a depth or height (hereinafter “height”) h₁ of the shaft 4 indicates how far the shaft 4 extends along the y-axis. Meanwhile, cross-sectional widths or diameters of the shaft 4 may be measured along different xz-planes. In other examples or scenarios, the shaft 4 may have an elliptical cross section, and the cross-sectional width of the shaft 4 may refer to a minor axis.

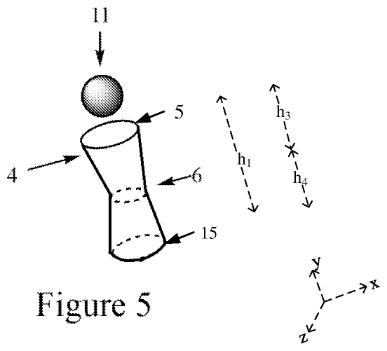

As will be described in the subsequent FIGS. 5-12, the shaft 4 is not to be construed as being limited to a truncated cone. In addition, the terms “width” or “cross-sectional width” may refer to either a minor axis or a major axis, depending on a context and/or which entity (e.g., shaft 4 or bead 11) is referred to. For example, a reference to a width or a cross-sectional width of the shaft 4 being larger than a width or a cross-sectional width of the bead 11 may be construed to mean that a minor axis of the shaft 4 is larger than a major axis of the bead 11.

### Beads

Beads 11 are preferably substantially spherical with each bead comprising multiple copies of the same unique compound as compared to other beads. When beads 11 are spherical, diameter and height are identical. When a bead 11 is non-spherical, or has different dimensions along different axes (e.g., major axis, minor axis, height), as long as a first dimension of the bead 11 exceeds a minor axis of the shaft 4 and a second dimension of the bead 11 exceeds a major axis of the shaft 4, the bead 11 will be captured or retained within the shaft 4. Beads 11 are an example of an assay component, as illustrated, for example, in FIGS. 2A-2C, 3A, 5, and 11.

### Assay Device

Assay device 20—corresponds to a high throughput assay device containing a multiplicity of wells 21 where assays are conducted using a multiple copies of a single test compound, as illustrated in FIGS. 4A-4B.

### Containment Cap

Containment cap 30—corresponds to a cap that is sized to fit over dispenser 1, as illustrated in FIGS. 3A-3B. Containment cap 30 comprises an intake port 31 that delivers beads 11 to shafts 4 of dispenser 1 resulting in a single bead 11 in each shaft 4. Containment cap 30 optionally has an outlet port or outlet (hereinafter “outlet”) 32 on its opposite side so as to retrieve beads 11 that are not captured by a shaft 4. Such beads 11 are diverted to the outlet 32 along a positive x-direction. Containment cap 30 allows for flowing in beads 11 into shaft 4. Once deposited, containment cap 30 can be removed. In addition, excess beads 11 exiting either the outlet 32 or through the bottom 6 of shaft 4 can be collected for further use. In one embodiment, one or more smaller beads 12, each of which has a width that is less than a smallest width within the shaft 4, may flow or traverse through the shaft 4 into a channel or lane (hereinafter “channel”) 17 below the shaft 4, as illustrated in FIGS. 3C-3D.

### Cell

Cell is a mammalian cell such as a murine cell, a porcine cell, a primate cell (including a human cell), and the like. Cell can be used in assay device 20 to assess the biological activity of a test compound.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

“Optional” or “optionally” means that the subsequently described event or circumstance can or cannot occur, and that the description includes instances where the event or circumstance occurs and instances where it does not.

The term “about” when used before a numerical designation, e.g., temperature, time, amount, concentration, and such other, including a range, indicates approximations which may vary by (+) or (−) 10%, 5%, 1%, or any subrange or subvalue there between.

For example, the term “about” when used with regard to an amount means that the amount may vary by +/−20%. It is contemplated that the diameter of the beads may be ±10% or ±20% from the stated average diameter.

“Comprising” or “comprises” is intended to mean that the compositions and methods include the recited elements, but not excluding others.

“Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention.

“Consisting of” shall mean excluding more than trace elements of other ingredients and substantial method steps. Embodiments defined by each of these transition terms are within the scope of this invention.

The term “assay device” refers to a device that is capable of simultaneously assaying multiple test compounds each in a single well against a target. Such devices contain a multiplicity of wells where each well preferably contains an assay component such as a bead which provides multiple copies of substantially the same compound. The device comprises a multiplicity of wells such as up to 2,000,000 or more. In one embodiment, the number of wells ranges from 5,000 to about 2,000,000. In one embodiment, the well density on the device is at least 10 wells per square millimeter and the number of wells is at least about 50,000.

The term “assay component” refers to micron sized, shaped components that are used in conducting a particular assay. In one embodiment, the assay component is a bead. In another embodiment, the assay component is a mammalian cell. In yet another embodiment, the assay component includes both beads and cells.

The term “bead” refers to beads 11 well known in the art for use in combinatorial chemistry. In one embodiment, the surface of bead 11 comprises a multiplicity of the same test compound bound thereto through a cleavable linker. Beads 11 may also comprise DNA barcodes that record the structure of the test compound or the synthetic steps used to synthesize the compounds and/or a mRNA capturing component which optionally can be combined to the DNA barcodes. These barcodes are attached to beads 11 either by cleavable or non-cleavable linker. If the barcodes are attached via a cleavable linker, then preferably, the cleavable linker used with the barcodes is cleaved by a mechanism different than that required to release the test compound from the bead.

In another embodiment, bead 11 contains multiple copies of the same reporter molecule. One example of a reporter molecule is a fluorescent molecule linked to bead 11 via a cleavable linker. Preferably, the reporter molecule is attached using the same cleavable linker that is used to bind the test compound to bead 11. When so used, bead 11 may include a quencher molecule (not shown) that is bound proximate to the fluorescent molecule on bead 11 so as to attenuate the fluorescence generated. Typically, the quencher molecule is bound to the bead by either a non-cleavable bond or by a cleavable bond that is cleaved by a mechanism that is different than the cleavable linker used to bind the fluorescent molecule to the bead.

Alternatively, the quencher is bound to the bead by the same linker used to bind the test compound to the bead. In this embodiment, the fluorescent compound is bound to the linker by a non-cleavable bond or by a cleavable bond that is cleaved by a mechanism that is different from the cleavable linker used to bind the quencher to the bead.

During an assay, knowledge of the extent of test compound released from bead 11 by a stimulus that cleaves the cleavable bond may be essential to that assay. Using bead 11 with a reporter molecule can provide that knowledge by measuring the change in fluorescence generated by decoupling the fluorescent compound away from the quencher against a standard curve.

For example, when the reporter molecule and the test compound are bound to the bead by the same cleavable linker, release of the test compound by the stimulus that breaks the cleavable linker will also release the reporter molecule in the same quantifiable manner. In doing so, the reporter molecule and the quencher are decoupled and the resulting change in fluorescence correlates to the amount of test compound released. See, e.g., U.S. Patent Application Pub. No. 2019/0358629, now U.S. Pat. No. 10,828,643, each of which is incorporated herein by reference in its entirety.

Alternatively, when the quencher molecule and the test compound are bound to the bead by the same cleavable linker, release of the test compound by the stimulus that breaks the cleavable linker will also release the quencher in the same quantifiable manner. In doing so, the reporter molecule and the quencher are decoupled and the resulting change in fluorescence correlates to the amount of test compound released.

In another alternative embodiment, the quencher molecule, the test compound and the reporter compound are all attached to bead 11 by the same cleavable linker such that all of these are cleaved from bead 11 by the applied stimulus. In doing so, the reporter molecule and the quencher molecule become decoupled from each other in the aqueous environment of the assay. This results in a change in fluorescence that correlates to the amount of the test compound released.

Beads 11 are typically polymeric in form. Numerous beads 11 are commercially available and have varying sizes, e.g., about 0.1 microns to about 50 or more microns including amino functionalized beads, carboxyl functionalized beads, magnetic beads with functional groups, etc. See, for example, Spherotech, Inc., Lake Forest, Illinois, USA, and Agilent, Inc., Santa Clara, California, USA. These beads are readily functionalized to contain a test compound and/or a reporter molecule using conventional chemistry well known in the art. It is understood that beads with a nominal diameter of about 25 microns include beads that are smaller and larger than about 25 microns with the number average being about 25 microns.

In one embodiment, the assay component is a viable mammalian cell such as a human cell. This cell is used in the assay to assess the biological activity, if any, of a given test compound. Assays using mammalian cells are well known in the art. Suitable cells include cancer cells, beta cells responsible for insulin expression, neurons, and the like.

The term “test compound” means a compound releasably bound to a bead 11 that, when released, is to be tested for biological activity in an assay conducted in well 21 of assay device 20.

The term “releasably bound” means that a test compound bound to bead 11 can be released by application of stimuli that breaks the bond. Such bonds are sometimes referred to herein as “cleavable” bonds. The art is replete with examples of cleavable bonds and the appropriate stimulus that breaks that bond. Non-limiting examples of cleavable bonds include those that are released by pH changes, enzymatic activity, oxidative changes, redox, UV light, infrared light, ultrasound, changes in magnetic field, to name a few. A comprehensive summary of such cleavable bonds and the corresponding stimuli required to cleave these bonds is provided by Taresco, V., Alexander, C., Singh, N. and Pearce, A. K. (2018), Stimuli-Responsive Prodrug Chemistries for Drug Delivery. Adv. Therap., 1: 1800030, onlinelibrary.wiley.com/doi/full/10.1002/adtp.201800030, which is incorporated herein by reference in its entirety.

The term “shaft” refers to a shaft, indentation, cavity, or hole 4 traversing from the top surface 2 and through the bottom surface 3 of dispenser 1. Said shaft 4 is sized and/or shaped to capture and hold one or more assay components, such as the beads 11, as described herein. The size of shaft 4 is correlated to the size of assay component 3 so as to ensure that only one assay component, such as a single bead 11, is captured in a single shaft 4. Shaft 4 captures a single assay component so that single component can be transferred to a single well 21 in an assay device 21 in a reliable manner. Therefore, an acquired assay result may directly be attributed or correlated to, or caused by, compounds present on that single assay component. On the other hand, if multiple assay components were transferred simultaneously to the single well 21, an assay result could not be directly attributed to any one of the individual assay components or corresponding compounds present on the individual assay components. In such a manner, by transferring or directing only a single assay component to the single well 21 at one time, results on an assay may be ascertained to a specific compound, thus, greatly enhancing an accuracy, reliability, and efficiency of an assay. In one embodiment, the capturing/release mechanism of shaft 4 is gravity assisted based on the diameter that is reduced at the second opening 6 as compared to the first opening 5.

The capturing mechanism of the assay component is based on a diameter 7 of shaft 4 and the rate of reduction in that diameter with respect to the height h₁ of the shaft 4, which, in turn, dictates how far down the shaft 4 the assay component can travel. In one embodiment, the first opening 5 is at least about 110% of the average width of the assay component, such as bead 11. The height h₃ of shaft 4 is set to at least about 110% of the average width of the assay component, such as bead 11, so as to exclude the possibility that 2 or more assay components can fit into and be retained in shaft 4 simultaneously. If two or more assay components were simultaneously retained within the shaft 4, then the two or more assay components may be transferred simultaneously to the single well 21, leading to uncertain and/or unreliable assay results. In one embodiment, the second opening 6, which may be a narrowest opening, width, or diameter within the shaft 4, is about 70% of the average size or width of an assay component. In another embodiment, the second opening 6 is about 80% or about 85% or about 90% of the width or diameter of assay component 10. Using the aforementioned relative dimensions of the first opening 5 and the second opening 6, the shaft 4 may retain assay components having a sufficient range of widths or diameters. Additionally, utilizing these relative dimensions may reduce an amount of dead space or extraneous space within the shaft 4 after an assay component has already been captured. The reduced amount of dead or extraneous space would prevent or reduce a possibility that additional assay components may be stuck or lodged atop the already captured assay component or within a crevice following the capture of the already captured assay component. Otherwise, if a relative difference in width or diameter between the first opening 5 and the second opening 6 is too large, or exceeds a threshold proportion, a wide range of beads having different widths or diameters might be captured by the shaft 4, but an excessive amount of unused space may be left following the capture of a bead within the shaft 4.

Different shafts 4 are illustrated in FIGS. 5-12 and 13A-13D. The shafts 4 illustrated in any of FIGS. 5-12 and 13A-13D may be implemented in conjunction with any of FIGS. 1, 2A-2D, 3A-3G, and 4A-4B. In FIG. 5, the shaft 4 may include an hourglass profile or contour. In particular, the shaft 4 may include a first portion or a first section (hereinafter “first portion”), between the first opening 5 and the second opening 6, at which a cross sectional width or diameter decreases with respect to the height h₁ of the shaft 4 (e.g., moving in a negative y-direction) and a second portion or a second section (hereinafter “second portion”), between the second opening 6 and a third opening 15 at a bottom of the shaft 4, at which a cross sectional width or diameter increases with respect to the height h₁ of the shaft 4. The second opening 6 may be situated within the interior of the shaft 4. In FIG. 5, the second opening 6 represents a demarcation between the first portion and the second portion, and the second opening 6 may be, or correspond to, a cross section that has a smallest width or diameter, compared to any other cross sections, within the shaft 4. In one embodiment, as shown in FIG. 5, the second portion is directly connected to the first portion without any intervening portions. However, in another embodiment, an intervening portion may be connected in between the first portion and the second portion. This intervening portion may have a constant or variable width, which, for example, decreases or increases, or alternately decreases and increases, along a height h₁ (e.g., moving along the negative y-direction). The second opening 6 may be equidistant with respect to the first opening 5 and the third opening 15, or, may be closer to the first opening 5, or the third opening 15. In other words, a height h₃ of the first section may be equal to or different from a height h₄ of the second section. In FIG. 5, a first rate at which the cross sectional width or diameter decreases with respect to the height h₁ of the shaft 4 is constant in the first section, and/or a second rate at which the cross sectional width or diameter increases with respect to the height h₁ of the shaft 4 is constant in the second section. The first rate may be equal to or different from the second rate. Such an hourglass profile may promote adhesion of a bead 11 to the shaft 4. The third opening 15 may have a smaller or larger width compared to that of the first opening 5.

In FIG. 6, the shaft 4 may include a different hourglass profile or contour.

Unlike the shaft 4 illustrated in FIG. 5, the shaft 4 in FIG. 6 may exhibit a first variable or nonconstant rate at which the cross-sectional width or diameter decreases with respect to the height h₁ of the shaft 4 in a first portion (e.g., moving in a negative y-direction), and/or a second variable or nonconstant rate at which the cross sectional width or diameter increases with respect to the height h₁ of the shaft 4 in a second portion. The first portion may be situated between the first opening 5 and the second opening 6 and have a height h₃ while the second portion may be situated between the second opening 6 and the third opening 15 and have a height h₄. The height h₃ may be equal to or different from the height h₄. In one embodiment, as shown in FIG. 6, the second portion is directly connected to the first portion without any intervening portions. However, in another embodiment, an intervening portion may be connected in between the first portion and the second portion. This intervening portion may have a constant or variable width, which, for example, decreases or increases, or alternately decreases and increases, along a height h₁ (e.g., moving along the negative y-direction). A rate of change of the first variable rate may be negative or decreasing, with respect to the height h₁ of the shaft 4, meaning that, approaching the second opening 6 from the first opening 5, the cross-sectional width or diameter decreases more and more slowly. A rate of change of the second variable rate may be positive or increasing, with respect to the height h₁ of the shaft 4, meaning that, approaching the third opening 15 from the second opening 6, the cross-sectional width or diameter increases more and more quickly. The shaft 4 in FIG. 6 may have a concave contour or profile. The third opening 15 may have a smaller or larger width compared to that of the first opening 5.

In FIG. 7, the shaft 4 may include a different hourglass profile or contour from that in FIGS. 5 and 6. The shaft 4 in FIG. 7 may have a first variable or nonconstant rate at which the cross-sectional width or diameter decreases with respect to the height h₁ of the shaft 4 in a first portion (e.g., moving in a negative y-direction), and/or a second variable or nonconstant rate at which the cross sectional width or diameter increases with respect to the height h₁ of the shaft 4 in a second portion. The first portion may be situated between the first opening 5 and the second opening 6 and have a height h₃ while the second portion may be situated between the second opening 6 and the third opening 15 and have a height h₄. The height h₃ may be equal to or different from the height h₄. In one embodiment, as shown in FIG. 7, the second portion is directly connected to the first portion without any intervening portions. However, in another embodiment, an intervening portion may be connected in between the first portion and the second portion. This intervening portion may have a constant or variable width, which, for example, decreases or increases, or alternately decreases and increases, along a height h₁ (e.g., moving along the negative y-direction). A rate of change of the first variable rate may be increasing, with respect to the height h₁ of the shaft 4, meaning that, approaching the second opening 6 from the first opening 5, the cross-sectional width or diameter decreases more and more rapidly. A rate of change of the second variable rate may be decreasing, with respect to the height h₁ of the shaft 4, meaning that, approaching the third opening 15 from the second opening 6, the cross-sectional width or diameter increases more and more slowly. The shaft 4 in FIG. 6 may have a convex contour or profile. The third opening 15 may have a smaller or larger width compared to that of the first opening 5.

In FIG. 8, the shaft 4 may include a concave profile or contour, similar to the first portion of the shaft 4 illustrated in FIG. 6. The shaft 4 in FIG. 8 may exhibit a variable or nonconstant rate at which the cross-sectional width or diameter decreases with respect to the height h₁ of the shaft 4 (e.g., moving in a negative y-direction). A rate of change of the variable rate may be negative or decreasing, with respect to the height h₁ of the shaft 4, meaning that, moving down the shaft 4 in the negative y-direction, and approaching the second opening 6 from the first opening 5, the cross-sectional width or diameter decreases more and more slowly.

In FIG. 9, the shaft 4 may include a concave profile or contour, similar to the first portion of the shaft 4 illustrated in FIG. 6. The shaft 4 in FIG. 8 may exhibit a variable or nonconstant rate at which the cross-sectional width or diameter decreases with respect to the height h₁ of the shaft 4 (e.g., moving in a negative y-direction). A rate of change of the variable rate may be increasing, with respect to the height h₁ of the shaft 4, meaning that, moving down the shaft 4 in the negative y-direction, and approaching the second opening 6 from the first opening 5, the cross-sectional width or diameter decreases more and more rapidly.

In FIG. 10, the shaft 4 may include a first portion, extending a height h₃, in which a diameter or width w₂ is constant or nearly constant, and a second portion, extending a height h₄, in which a diameter or width w₃ is constant or nearly constant. w₃ is less than w₂. h₃ may be smaller or larger than, or equal to, h₄. In one embodiment, as shown in FIG. 10, the second portion is directly connected to the first portion without any intervening portions. However, in another embodiment, an intervening portion may be connected in between the first portion and the second portion. This intervening portion may have a constant or variable width, which, for example, decreases along a height h₁ (e.g., moving along the negative y-direction).

In FIG. 11, the shaft 4 may, in addition to including the first portion and the second portion as illustrated in FIG. 10, further include a third portion extending a height h₅, in which a diameter or width w₄ is constant or nearly constant. w₄ is larger than w₃. w₄ may be greater than, smaller than, or equal to w₂. The third portion may culminate as the third opening 15. In one embodiment, as shown in FIG. 11, the third portion is directly connected to the second portion without any intervening portions. However, in another embodiment, an intervening portion may be connected in between the second portion and the third portion. This intervening portion may have a constant or variable width, which, for example, decreases along a height h₁ (e.g., moving along the negative y-direction).

In FIG. 12, the shaft 4 may include a different hourglass profile or contour from that in FIGS. 5-7. The shaft 4 in FIG. 12 may have a first variable or nonconstant rate at which the cross-sectional width or diameter decreases with respect to the height h₁ of the shaft 4 in a first portion (e.g., moving in a negative y-direction), and/or a second variable or nonconstant rate at which the cross sectional width or diameter increases with respect to the height h₁ of the shaft 4 in a second portion. The first portion may be situated between the first opening 5 and the second opening 6 and have a height h₃ while the second portion may be situated between the second opening 6 and the third opening 15 and have a height h₄. The height h₃ may be equal to or different from the height h₄. In one embodiment, as shown in FIG. 12, the second portion is directly connected to the first portion without any intervening portions. However, in another embodiment, an intervening portion may be connected in between the first portion and the second portion. This intervening portion may have a constant or variable width, which, for example, decreases or increases, or alternately decreases and increases, along a height h₁ (e.g., moving along the negative y-direction). In the first portion, the profile of the shaft 4 may have an inflection point 61. From the first opening 5 up to the inflection point 61, a rate of change of the first variable rate may be increasing, with respect to the height h₁ of the shaft 4, meaning that, approaching the inflection point 61 from the first opening 5, the cross-sectional width or diameter decreases more and more rapidly. However, from the inflection point 61 up to the second opening 6, a rate of change of the first variable rate may be decreasing, with respect to the height h₁ of the shaft 4, meaning that, approaching the second opening 6 from the inflection point 61, the cross-sectional width or diameter decreases more and more slowly.

In the second portion, the profile of the shaft 4 may have a second inflection point 62. From the second opening 6 up to the inflection point 62, a rate of change of the second variable rate may be increasing, with respect to the height h₁ of the shaft 4, meaning that, approaching the inflection point 62 from the second opening 6, the cross-sectional width or diameter increases more and more rapidly. However, from the inflection point 62 up to the third opening 15, a rate of change of the second variable rate may be decreasing, with respect to the height h₁ of the shaft 4, meaning that, approaching the third opening 15 from the inflection point 62, the cross-sectional width or diameter increases more and more slowly. The third opening 15 may have a smaller or larger width compared to that of the first opening 5.

In FIGS. 13A-13D, the shaft 4 may include a zigzag profile, in which regions of changing cross-sectional width alternate with regions of constant or near-constant width. In particular, the shaft 4 may include the first opening 5 having a cross-sectional width of w₂. Immediately below the first opening 5, moving along the negative-y direction, may be a first region 71 in which a cross-sectional width decreases from w₂ to w₃. The first region 71 may extend a height h₂ in the negative-y direction. Immediately below the first region 71, moving along the negative-y direction, may be a second region 72 in which a cross-sectional width w₃ remains constant or relatively constant. The second region 72 may extend a height h₃ in the negative-y direction. Immediately below the second region 72, moving along the negative-y direction, may be a third region 73 in which a cross-sectional width decreases from w₃ to w₄. The third region 73 may extend a height h₄ in the negative-y direction. Immediately below the third region 73, moving along the negative-y direction, may be a fourth region 74 w₄ remains constant or relatively constant. The fourth region 74 may extend a height h₅ in the negative-y direction. Immediately below the fourth region 74, moving along the negative-y direction, may be a fifth region 75, in which a cross-sectional width decreases from w₄ to w₅. The fifth region 75 may extend a height h₆ in the negative-y direction. Immediately below the fifth region 75, moving along the negative-y direction, may be a sixth region 76 in which a cross-sectional width w₅ remains constant or relatively constant. The sixth region 76 may extend a height h₇ in the negative-y direction and terminate at the second opening 6. In some embodiments, the values of h₂, h₃, h₄, h₅, h₆, and h₇ may be equal, or at least some of the aforementioned values may be different. However, the aforementioned values may be relatively equal to one another in some embodiments. For example, a ratio between a largest value out of the values of h₂, h₃, h₄, h₅, h₆, and h₇ and a smallest value out of the values of h₂, h₃, h₄, h₅, h₆, and h₇ may not exceed two, or may not exceed 1.5. Additionally, angles of the first region 71, the third region 73, and the fifth region 75, with respect to the y-axis, may be equal to one another, or at least one of the aforementioned angles may be different. For illustrative purposes, an angle of the first region 71 with respect to the y-axis is shown as ⊖ in FIG. 13C. In some embodiments, the angles of the first region 71, the third region 73, and the fifth region 75, with respect to the y-axis may be less than 45 degrees, or less than 60 degrees. In some embodiments, the angles of the first region 71, the third region 73, and the fifth region 75, with respect to the y-axis may be between 30 degrees and 60 degrees. In some embodiments, the angles of the first region 71, the third region 73, and the fifth region 75, with respect to the y-axis may be between 15 degrees and 75 degrees. Although six regions are shown in FIGS. 13A-13D, any number of regions is contemplated.

Although the foregoing assumes that the slopes in the first region 71, the third region 73, and the fifth region 75 are constant, in some alternative embodiments, at least a portion of the slopes in the first region 71, the third region 73, and/or the fifth region 75 may be nonconstant. In other words, a rate of decrease of the cross sectional widths in the first region 71, the third region 73, and/or the fifth region 75, along the negative-y direction, may be variable, as illustrated, for example, in FIGS. 6-9 and 12.

In FIG. 13B, the bead 11 may contact, and be secured at, side walls at a boundary or intersection between the first region 71 and the second region 72. The bead 11 may not contact the shaft 4 at any other position. In FIG. 13C, a bead 81, smaller than the bead 11, may contact, and be secured at, side walls at a boundary or intersection between the third region 73 and the fourth region 74. The bead 81 may not contact the shaft 4 at any other position. In FIG. 13D, a bead 91, smaller than the bead 81, may contact, and be secured at, side walls at a boundary or intersection between the fifth region 75 and the sixth region 76. The bead 91 may not contact the shaft 4 at any other position. Thus, FIGS. 13B-13D illustrate various sized beads that may each be lodged within the shaft 4 at a single position. Because the beads 11, 81, and 91 may each be secured within the side walls of the shaft 4 at only a single location along the y-axis, at a boundary between two regions, the beads 11, 81, and 91 may be released into assay wells upon the shaft 4 being transposed without getting stuck in the shaft 4.

Other profiles or contours of the shaft 4, besides those illustrated explicitly in the FIGS. 2A-2D, 5-12, and 13A-13D, may be contemplated. Any combination of features illustrated or described with respect to the aforementioned features may be contemplated. For example, a shaft 4 may include one or more portions having constant widths or diameters, as shown in FIGS. 10-11, together with one or more portions having variable widths or diameters, as shown in FIGS. 5-9,12 and 13A-13D. As another example, a shaft 4 may include one or more portions having variable widths or diameters such that a rate of change of the widths or diameters is constant, together with one or more portions having variable widths or diameters such that a rate of change of the widths or diameters is increasing or decreasing. Any reference to a shaft 4 or shafts 4 may refer to any profiles or contours illustrated and described with respect to FIGS. 2A-2D, 5-12 and 13A-13D. In FIGS. 6-9 and 12, a rate of decrease of the cross sectional widths in the different regions, along the negative-y direction, may be variable.

While it is preferred that a substantially spherical assay component is used where the longest axis is uniform throughout, other shapes can be used. One such non-spherical shape useful herein is an orbiform which is solid having a uniform width throughout and is capable of rolling. Still other shapes that are useful herein are elliptical shapes. Preferred shapes that have elliptical cross-sections include ellipsoids having a ratio of long axis to short axis of greater than about 1 and less than about 1.5 and preferably less than about 1.2. When used herein, the term “axis” refers to the longest axis in the assay component.

### Dispenser

The ability to assay a very large combinatorial library of compounds typically entails the delivery of a single assay component, such as bead 11, into a single well 21 of assay device 20. In practice, there may be as many as about 2+ million wells 21 incorporated into assay device 20. As shown in FIGS. 3A, 3B, 4A and 4B, the diameters of well 21 in these assay devices 20 are significantly larger than the diameters or widths of shafts 4 of dispenser 1. Such a size differential makes adding a single assay component into a single well 21 of assay component, shown as bead 11, a technically challenging endeavor.

### Bead as the Assay Component

In this section, assay components are beads 11. These beads are preferably spherical to substantially spherical and preferably have a diameter of from about 0.5 to about 100 microns. FIG. 1 shows dispenser 1 having a plurality of shafts 4.

In more general terms, dispenser 1 of FIG. 1 has a top to bottom thickness 8 that is preferably at least about 0.1 mm to about 5 mm and contains a multiplicity of shafts 4. Thickness 8 may be any value or subrange within the recited ranges, including endpoints. Dispenser 1 comprises any of a number biocompatible, materials including but not limited to polymers such as cyclo olefin polymer (COP) which is commercially available from Zeon Corporation (Tokyo, Japan) under the trade name ZEONEX, cyclic olefin copolymers (COC) which are commercially available from a number of sources such as Polyplastics USA, Inc. (Farmington Hills, Michigan, USA), polyimides which are commercially available from a number of sources such as Putnam Plastics (Dayville, Connecticut, USA), polycarbonates which are commercially available from a number of sources such as Foster Corporation (Putnam, Connecticut, USA), polydimethylsiloxane which are commercially available from Edge Embossing (Medford, Massachusetts, USA) and polymethylmethacryate which is commercially available from Parchem Fine & Specialty Chemicals (New Rochelle, New York, USA).

Dispensers 1 described herein can be readily prepared by hot embossing methods which are well known in the art. Such hot embossing methods use a sheet of thermoplastic polymer which is heated to a temperature slightly higher than its glass transition temperature in order to soften the plastic. A stamp is selected that comprises a number of prongs placed in a desired pattern on its surface. Each prong is sized to have width or diameter and a depth correlating to the size and shape of shafts 4 as described above. In some embodiments, the prongs may include or resemble a truncated cone or frustum in nature, but otherwise can be any shape desired provided that cross-sectional widths are variable. Using the prongs, a dispenser 1 may be generated or prepared such that the second opening 6 may be narrower, or have a different cross-sectional width, than the first opening 5. The stamp is sized so that the entirety of the prongs fits through the sheet to a predetermined depth. Sufficient force is applied to the stamp so as to ensure that the desired length of the prongs sink into and through the sheet. The force required is dependent on the degree of softness of the sheet and is readily ascertainable by the skilled artisan. As the sheet cools, the prongs are removed so as to provide for a sheet now containing shafts 4 as per FIG. 1.

Alternatively, dispenser 1 of FIG. 1 can be prepared by conventional injection molding using two mold halves—one with protrusions corresponding to those of the stamp (male mold half) and the other forming the base of the device (female mold half). The mold halves are juxtaposed to each other so as to form shafts 4 in the shape of the device 1 illustrated in FIG. 1. Injection of a monomer or reactive oligomer composition into this cavity followed by polymerization provides for a dispenser 1 now containing shafts 4 as per FIG. 1.

In embodiments, dispenser 1 can be fabricated in conjunction with assay device 20 to assure proper alignment of shafts 4 with wells 21.

As to FIG. 2A, this figure illustrates a spherical bead 11 juxtaposed above shaft 4 which is configured such that it is sized to fully fit bead 11 in the interior of shaft 4. FIG. 2B illustrates spherical bead 11 inside of shaft 4; whereas, FIG. 2C illustrates spherical bead 11 having a diameter larger than top opening 5 which bead lies partially inside and partially outside shaft 4. In this case, there is a sufficient volume bead 11 inside shaft 4 in a manner that securely retains said bead in said shaft. FIG. 2D illustrates removal of a smaller bead 12 having a diameter smaller than the narrowest diameter of shaft 4 wherein the smaller bead 12 exits the bottom of shaft 4. In other words, in FIG. 2D, the smaller bead 12 is not retained or captured within the shaft 4. Thus, loading or capture of a single bead 4 within the shaft 4, along with size exclusion of the smaller beads 12, may be accomplished seamlessly in a single step, without manual intervention. Further details of this scenario, in which the smaller bead 12 is not retained or captured, are illustrated in FIGS. 3C and 3D, and elucidated in the associated description.

Referring back to FIGS. 2A and 2B, the diameter of the first opening 5 is larger than the diameter of spherical bead 11 such that the bead lies inside the shaft. In one embodiment, the diameter of the first opening 5 ranges up to 150% of the diameter of spherical bead 11, or 150% of an average diameter of the spherical bead 11. Thus, in such an embodiment, the diameter of the first opening 5 may be sized so as to avoid leaving excess amounts of unoccupied space in order to reduce or eliminate a possibility of a second bead being lodged entirely or partially on top of an already captured bead 11, or within a crevice of the shaft 4 after a bead has already been captured or retained within the shaft 4. In addition, that second bead may not be able to traverse a space already occupied by the bead, and may not be able to exit through the shaft 4 because the second bead is blocked by the already captured bead. For example, if the first opening 5 had a diameter of 1000% (e.g., ten times) of an average diameter of the spherical bead 11, a probability of multiple beads being stuck or lodged within the shaft 4 may exceed a permitted threshold probability. At the same time, the diameter of the first opening 5 should be sized to permit a sufficient distribution of differently sized beads 11 into the shaft 4, or else an excessive number of beads 11 would fail to be retained within the shaft 4. The use of shafts 4 having variable or nonconstant widths or diameters, and spherical or elliptical beads 11, allows smaller beads to simply pass through the shaft 4 rather than the two beads being simultaneously retained within the shaft 4. As a result, the two beads would not simultaneously populate a single well 21.

### Loading

The loading of beads 11 into shafts 4 of dispenser 1 can be accomplished in any of a number of art recognized procedures. As shown in FIG. 3A, containment cap 30 comprises an inlet port 31 for introducing beads 11 and an outlet port 32 for recovering excess beads 11. Containment cap 30 is sized to fit over dispenser 1 and is aligned with dispenser 1 such that both inlet port 31 and outlet port 32 are aligned over dispenser 1.

In one preferred embodiment, containment cap 30 is sized and shaped to mate onto dispenser 1 in any number of well-known features including interlocking protrusions extending upward from disperser 1 that extend into holes in the body of containment cap 30. Alternatively, clips or other locking devices/configurations can be fitted onto either dispenser 1 or containment cap 30 that snap onto and lock both dispenser 1 and containment cap 30 into a fixed configuration. The specific locking mechanism is not critical.

A funnel-like cone 40 is sized such that the narrower end of that cone fits into inlet port 31 of containment cap 30; whereas, the wider end of said cone allows for the addition of beads 11. Beads 11 are delivered either alone or in a fluid through inlet port 31 and onto the surface of dispenser 1 in a manner where beads 11 move from the inlet port 31 toward the outlet port 32 (e.g., along a positive x-direction). Beads 11 may be funneled into the shafts 4 until each shaft 4 retains a single bead 11, and any excess beads are recycled through outlet port 32 for recycling into another dispenser 1. The excess beads may exceed a threshold width or diameter, for example, a width or diameter of the first opening 5, and thus be unable to enter any of the shafts 4 via the first opening 5. In one embodiment, the excess beads may be analyzed and/or redirected into a different set of shafts having larger widths or diameters compared to the shafts 4. Therefore, the excess beads may automatically be transported and processed according to their sizes in successive iterations or stages, with no or minimal manual intervention.

As illustrated in FIGS. 3A and 3B, a height h₁ of the shaft 4 denotes a distance that the shaft 4 extends along a y-direction. The height h₁ may be sufficient to retain a single bead 11, but at the same time, be limited to reduce an amount of dead space or extraneous space within the shaft 4. Thus, a possibility of additional beads getting stuck or lodged atop an already captured bead 11, or within a crevice following the capture of the bead 11, may be reduced. In one embodiment, the height h₁ may be between 0.5 and 2 times an average diameter of the beads 11. In another embodiment, the height h₁ may be between 0.5 and 1.25 times an average diameter of the beads 11. In another embodiment, the height h₁ may be between 0.75 and 1.25 times an average diameter of the beads 11.

In one embodiment, the one or more shafts 4 may include truncated cones or frustums. The shafts 4 may have a slant angle or a base angle (hereinafter “slant angle”), measured between the first opening 5 and a lateral, or side, surface. This slant angle may range from about 50 degrees to 80 degrees relative to the top surface 2 of dispenser 1. A lower the slant angle, a faster a rate of change of the width or diameter of the shaft 4 with respect to the height h₁. If the rate of change exceeds a threshold, the amount of empty space remaining even after one bead 11 is already lodged or secured within the shaft 4 may increase a possibility that an additional bead may be lodged above the one bead 11, or within a remaining crevice of the shaft 4. Thus, the slant angle may be selected to be above a threshold angle, such as 30 degrees. At the same time, the slant angle should be selected to permit beads having a sufficient, and not overly narrow, range of distributions to be directed into the shaft 4. For example, if the slant angle is too close to 90 degrees, the rate of change of the width or diameter of the shaft 4 with respect to the height h₁ may be minimal, and only beads having a narrow range of bead sizes would be directed into the shaft 4. Therefore, the slant angle may be selected to be below a threshold angle, such as 85 degrees.

In one embodiment, cone 40 is tilted so that beads 11 flow in a partially horizontal direction allowing the beads to fill shaft 4. In another embodiment, dispenser 1 is on a slight incline where the side adjacent to the inlet port 31 of containment cap 30 is higher than that of side adjacent to the outlet port 32 of containment cap 30. Such can be accomplished by applying a slight decline of at least about 1° as measured from the inlet port to the outlet port. Preferred declines of at from at least about 1° to about 10°, and more preferably about 1° to about 5° (or any value or subrange within the recited ranges, including endpoints), enable beads 11 to traverse the decline at such a rate that they are readily captured by shafts 4 in dispenser 1 while allowing smaller beads 11 to pass through the shaft 4 and larger excess beads 11 to be transmitted through the recovery port 32 and then captured. The size and contour of the conical shape of shaft 4 are designed to remove any smaller beads from populating these shafts in a manner that could result in two beads 11 being deposited simultaneously into a single well 21. As shown in FIG. 3B, this process successfully allows a single bead 11 having a width of d₁ (e.g., indicating that a major axis or both axes have a width of d₁) to be deposited into a single shaft 4 of dispenser 1.

As illustrated in FIG. 3C, smaller beads 12, which have respective widths or diameters of d₂ that are smaller than a narrowest width or diameter m₁ of the shaft 4, are directed out of the shaft 4. In one embodiment, the smaller beads 12 are directed out of the shaft 4 to a channel 17. The channel 17 may be a fluidic channel, such as a microfluidic channel. Although the channel 17 is illustrated in FIG. 3C as downwardly sloping so that gravity can push or assist the smaller beads 12 through the channel 17, the channel 17 may also have a level, or flat slope, as illustrated in FIG. 3D. In some embodiments, the smaller beads 12 may, in addition or as an alternative to a gravitational force, be pushed or assisted along the channel 17 via a fluidic pressure and/or other force, such as a suction or vacuum force. A minimum height h₂ of the channel 17, extending along the y-axis, may be at least a minimum width m₁ of the shaft 4 so that once the smaller beads 12 pass through the shaft 4, the smaller beads 12 would avoid getting stuck within the channel 17. In FIG. 3D, The smaller beads 12 may traverse the channel 17 and pass into a receptacle or container (hereinafter “receptacle”) 18. From the receptacle 18, the smaller beads 12 may be diverted or directed into a funnel, tube, pipe, channel, conduit, or guide (hereinafter “funnel”) 19, which may be implemented in a similar, analogous, or same manner as the funnel-shaped cone 40. A minimum width or diameter of the funnel 19 may be at least w so that all smaller beads 12 would pass through the funnel 19 without getting stuck. The entry of the beads into the funnel 19 from the receptacle 8 may be regulated using a gate 13 or other similar mechanism. The gate 13 may be mechanically and/or electrically controlled. In other examples, the gate 13 may be turned or switched open at certain fixed or variable time intervals, while remaining closed at other time intervals. In some examples, the smaller beads 12 may directly pass from the channel 17 into the funnel 19, instead of being temporarily retained within the receptacle 18. In other words, the channel 17 may directly connect or lead into the funnel 19.

Once the smaller beads 12 enter the funnel 19, the smaller beads 12 may then be passed or directed into a set of smaller shafts 54 having minimum widths or diameters m₂ smaller than those of the shafts 4. A subset of the smaller beads 12 may be captured within the smaller shafts while remaining smaller beads may further pass through the smaller shafts. In such a manner, the smaller beads 12 may be successively or iteratively transmitted through smaller shafts until all or nearly all beads have been retained within individual shafts and are ready to be placed into wells to be assayed, with no or minimal manual intervention. During each iteration or cycle, smaller beads may be retained within shafts and/or assayed. Yet another benefit may be that if an amount of compound linked to the beads is correlated to, or proportion to, a width or diameter of the beads, successive or consecutive assays can further determine or ascertain whether and how an amount of compound affects assay results. As only an illustrative, non-limiting scenario, a first iteration may involve conducting assays on the beads 11 which have widths or diameters between 0.8 and 1 times a threshold width or diameter. A second iteration may involve conducting assays on the smaller beads 12 which have widths or diameters between 0.64 and 0.8 times a threshold width or diameter. Yet a third iteration may involve conducting assays on even smaller beads which have widths or diameters between 0.512 and 0.64 times a threshold width or diameter, and so on. Although the receptacle 18 and the funnel 19 are only illustrated in FIG. 3D, the receptacle 18 and the funnel 19 may be implemented in FIG. 3C in a same or similar manner.

Meanwhile, FIGS. 3E-3G illustrate a mechanism of size exclusion to obtain beads having a particular range of widths in two stages, a first stage in which beads larger than a second threshold width are excluded or removed via preliminary channels and a second stage in which beads smaller than a first threshold width are excluded or removed. The first threshold width may be less than the second threshold width. Therefore, beads between the first threshold width and the second threshold width are retained. FIG. 3E illustrates an implementation using the closing and opening of valves 24, 25, 26, and 27, during different procedures such as bead loading or dispensing, releasing beads jammed or stuck in the channels 55 and/or 56, which are larger than the second threshold width, releasing beads that are smaller than the first threshold width, and releasing beads stuck within the path 43 but not lodged within the channels 45, 46, 47, or 48.

In FIGS. 3E-3G, a funnel-like cone 40, same or similar to that illustrated in FIG. 3A, may store or house beads 11, 41, and 51 having various widths. For example, the beads 11 have widths d₁, the beads 41 have widths d₃ smaller than d₁, and the beads 51 have widths d₄ larger than d₁. The beads 11, 41, and 51 may be introduced, via the funnel-like cone 40 or other mechanism or device that stores beads, into a first stage 52. The beads 11, 41, and 51 may enter the first stage 52 into a path or channel (hereinafter “path”) 53. Once the beads 11, 41, and 51 enter the path 53, the beads 11, 41, and 51 may traverse through a funnel or channel 55 (hereinafter “channel”) or a channel 56. The channels 55 and 56 permit beads smaller than a second threshold width m₃ to pass through while preventing beads larger than the second threshold width m₃ from passing through. The channels 55 and 56 are illustrated in FIGS. 3E-3G to have an increasing width moving along a negative y-direction. In particular, the channels 55 and 56 have widths m₃ at their respective entrances and widths m₄ at their respective exits. m₄ may be larger than m₃. Although the widths of the channels 55 and 56 are illustrated as increasing throughout an entire height (along a y-direction) of the channels 55 and 56, in some alternate embodiments, the widths of the channels 55 and 56 may be increasing at only a top section of each of the channels 55 and 56, such as, a top half, a top third, or a top two-thirds, with respect to the y-direction, while remaining relatively constant or constant at a remaining section of the channels 55 and 56. Slant angles of the channels 55 and 56, with respect to a x-axis, may be between 30 to 85 degrees. In other alternate embodiments, the channels 55 and 56 may have constant or relatively constant widths with respect to a negative y-direction. Although only two channels are shown, any number of channels may be contemplated.

Here, the bead 51 may have a width d₄ that exceeds the width m₃ of the channel 55. Therefore, the bead 51 may be prevented from passing through the channel 55. Meanwhile, the beads 11 and 41 may have widths d₁ and d₃, respectively. Both d₁ and d₃ may be smaller than m₃. Therefore, the beads 11 and 41 may pass through the channel 56. The beads such as the bead 51 that are lodged or stuck within at least a portion of the channel 55 or 56, such as a top portion of the channel 55 or 56, may be released or dislodged via ultrasonication, gravity, and/or fluid flow.

Beads 11 and 41, which are released through the channel 56, may pass into a second stage 42. At the second stage 42, the beads 11 and 41 may traverse a path 43 and into one of channels 45, 46, 47, and 48. Each of the channels 45, 46, 47, and 48 may have a smaller width of m₁ (e.g., a first threshold) at respective bottoms of the channels 45, 46, 47, and 48. Meanwhile, a larger width of the channels 45, 46, 47, and 48, denoted as m₅ at respective tops of the channels 45, 46, 47, and 48, may be equal to or larger than m₃. Here, the width d₁ corresponding to the bead 11 may be larger than m₁ and the width d₃ corresponding to the bead 41 may be smaller than m₁. Therefore, the bead 11 may be retained within the channel 45 while the bead 41 may pass through the channel 45. Any beads, such as the bead 11, that are retained within a channel, may be transposed and/or passed into an assay device to be assayed, as will be illustrated in FIGS. 4A and 4B. For example, the set of channels 45, 46, 47, and 48, as illustrated in FIG. 3F within a dashed rectangle, may be removed and transposed onto an assay device. Although four channels 45, 46, 47, and 48 are illustrated, any number of channels may be implemented within the second stage 42.

In such a manner, beads between a first threshold width and a second threshold width may be retained for a subsequent assay. As one example, the first threshold width may be 9 microns or 8 microns, while the second threshold width may be 11 microns or 12 microns. Therefore, beads within the dispenser 1 may have respective widths that are within a threshold range of a target width. For example, a range of widths of the beads may be within 10 percent or 20 percent of a particular target width, which may be 10 microns. In other embodiments, the range of widths of the beads may be within 2 percent or within 5 percent of a particular target width. Such size control may be important in conducting reliable assays in order to ensure that uniform or nearly uniform amounts or concentrations of compounds are being compared across wells. Because the beads include chemicals, and a surface area of a bead relates to a square of a width, a bead being twice a width as another bead likely means that one bead would have four times as much chemical as another bead. Thus, even small differences in bead size may result in larger differences in chemical amounts or concentrations on a bead. The implementations of FIGS. 3E-3G may be combined with those in FIGS. 3C-3D, for example, to successively obtain particular ranges of bead sizes over different iterations, as alluded to above.

FIG. 3E illustrates valves that are controlled to open and close during different procedures. The valves include a first valve 24 disposed at an outlet of the dispenser 40, a second valve 25 disposed at an outlet of the collector 57, a third valve 26 disposed at an outlet of the path 43, and a fourth valve 27 disposed below and downstream of the channels 45, 46, 47, and 48. Any or all of the valves 24, 25, 26, and 27 may be fluidic or microfluidic valves, and may be controlled electronically and/or mechanically. Any or all of the valves 24, 25, 26, and 27 may be two-way valves.

During loading of beads (e.g., the beads 11, 41, and 51) through the dispenser 40, the first valve 24 may be opened to permit a flow of beads through the dispenser 40. The second valve 25 and the third valve 26 may be closed. The fourth valve 27 may be opened to purge smaller beads and prevent accumulation of smaller beads. During releasing of beads (e.g., the beads 51) stuck within the channels 55 and 56, within the path 53, and within the collector 57, the second valve 25 may be opened so that the beads 51 pass through and out of the collector 57. In some embodiments, the third valve 26 may also be opened in a reverse direction (e.g., towards the negative x-direction rather than the positive x-direction), according to a fluid flow 301. Thus, in the fluid flow 301, back flush and/or back pressure of fluid may result in ingress of fluid through the third valve 26 through the channels 55 and 56, to further guide beads through the second valve 25. In some embodiments, additionally or alternatively, the fluid jet 58 may propel beads out of the collector 57. Meanwhile, the first valve 24 and the fourth valve 27 may be closed during releasing of beads. During the process of pushing out the beads 41, which are smaller than the first threshold width, through the bottom 3, the fourth valve 27 may be opened so that any fluid flow, such as from a fluid jet 68, may push the beads 41 out through the fourth valve 27 along a x-direction. In some embodiments, the third valve 26 may also be opened in a reverse direction so that back pressure of fluid may pass from the path 43 in a negative-x direction through the channels 45, 46, 47, and 48 to further guide beads out through the fourth valve 27, according to a fluid flow 302. Although the fluid flow 302 is only illustrated as going through the channel 48, fluid from the fourth valve 27 may also go through the channels 47, 46, and/or 45. In some embodiments, additionally or alternatively, the fluid jet 68 and/or the fluid jet 49 may propel beads through the fourth valve 27. In particular, fluid from the fluid jet 49 may flow through the channels 45, 46, 47, and 48. Meanwhile, the first valve 24 and the second valve 25 may be closed.

During the process of extracting the desired beads 11, any beads that are caught within the channels 45, 46, 47, and 48, may be collected through the third valve 26. Thus, the third valve 26 may be opened. In some embodiments, optionally, the fourth valve 27 may also be opened in a reverse direction so that back flush and/or back pressure of fluid in a negative x-direction from the fourth valve 27 may propel beads through the path 43 and past the third valve 26, similar to the fluid flow 302. In some embodiments, additionally or alternatively, dislodging may occur via ultrasonication and/or gravity.

Alternatively, if the desired beads 11 are to be retained within the channels 45, 46, 47, and 48, then the aforementioned process of extracting the desired beads may be skipped. By retaining the desired beads 11, the channels may be flipped over by 180 degrees, inverted, or transposed so that the desired beads 11 will fall into an assay device, as will be illustrated in FIGS. 4A and 4B.

In some embodiments, the aforementioned operations of loading of beads, releasing of beads, pushing out the beads, and extracting beads of the desired sizes, may be conducted at certain time intervals. The time intervals may be fixed and/or periodic. For example, during a first time interval, the beads may be loaded. During a second time interval subsequent to the first time interval, the beads stuck or caught within the channels 55 and 56, within the path 53, and the collector 57 may be pushed out. During a third time interval subsequent to the first time interval, the beads 41 may be pushed out from the bottom 3. During a fourth time interval, the beads 11 of the desired sizes may be extracted, and inverted onto the assay device 20, as illustrated in FIGS. 4A and 4B. In alternative embodiments, rather than being conducted at time intervals, the aforementioned operations may be conducted based on concentrations of beads detected within the channels 55 and 56, within the path 53, the collector 57, at the bottom 3, and within the channels 45, 46, 47, and 48. The detection may be via imaging such as fluoroscopy.

Once all beads from the dispenser 40 have been processed or each of the channels of the second stage 42 has retained a bead, the channels 45, 46, 47, and 48, as illustrated in FIG. 3F inside the dashed rectangle, may be removed or disassembled and flipped over, inverted, or transposed into an assay device. Processing of the beads from the dispenser may entail either passing the beads through the channels of the first stage 52 or diverting the beads to the collector 57. Thus, the beads lodged within the channels 45, 46, 47, and 48 along with any other channels of the second stage 42, may be transferred to an assay device.

### Dispensing

As before, each of shafts 4 on dispenser 1 are preselected to align with a single well 21 on assay device 20. Any additional beads, which may be lodged or stuck on top of an already captured bead within a shaft 4, may be diverted from the shaft 4 towards the outlet 32 via an air, fluid, or vacuum pressure along or in proximity to the top surface 2. As illustrated in FIGS. 4A and 4B, dispensing beads 11 into wells 21 is accomplished by placing assay device 20 over dispenser 1 and ensuring that each shaft 4 is aligned with a corresponding well 21. Dispenser 1 and assay device 20 are preferably locked into place by a locking mechanism 23 which ensures that shafts 4 remain aligned with wells 21 during dispensing. Alignment can be confirmed by aligning markers (not shown) on the assay device 20 with corresponding markers (not shown) on dispenser 1. The mechanisms described in FIGS. 4A and 4B may be implemented in conjunction with relevant portions of other FIGURES, such as FIGS. 1, 2A-2D, 3A-3K, 5-12, and 13A-13D.

In FIG. 4A, an optional small gap 22 can be present between dispenser 1 and assay device 20 provided that the gap 22 is less than the widths or diameters of beads 11 and preferably about 50% or less than the widths or diameters of beads 11. The gap 22 may be adjustable in height (e.g., along the y-axis) using the locking mechanism 23, and may be controlled mechanically and/or electrically. For example, the locking mechanism 23 may be secured within ridges or rails on the assay device 20 and/or the shafts 4, and relative positions at which the locking mechanism 23 is secured on the ridges or rails may be adjusted. The gap 22 therefore may be adjusted based on a range or a distribution of widths or diameters of the beads 11. In some exemplary embodiments, assay device 20 may be provided without the optional gap 22.

When alignment is confirmed, the combination of dispenser 1 and assay device 20 is merely flipped over so that dispenser 1 sits on top of assay device 20. For gravity-based release, a force or energy may be required, e.g., on the dispenser 1, to release beads 11 into wells 21. In one embodiment, the force or energy is at least about 1 Newton or at least about 0.01 Joule. Such can be applied by any method, e.g., back pressure, vacuum or suction pressure, tapping, vibration, sonication, centripetal force, temperature change, and the like. Because of the size distribution of the beads, some beads may be more tightly associated within the dispenser than others, and force (or additional force) may be required to dislodge them. The amount of force required to dislodge beads may be inversely proportional to the widths or diameters of the beads 11. The alignment of shafts 4 and wells 21 ensures that a single bead 11 is deposited into a single well 21 without a bead 11 spilling into a different well than its intended well.

### Cells as the Assay Component

Another example of an assay component is a cell which is used to evaluate its response to contact and/or uptake of a test compound during an assay. The cell can be added into dispenser 1 in a manner similar to bead 11 with the following caveats:
In an example in which the shaft 4 has a truncated conical profile, the shape of shaft 4 is based on the slant angle of the truncated cone which can be assessed by well-known geometric principles. In one embodiment, the slant angle may be less than 90 degrees relative to the top surface 2 of dispenser 1. In one embodiment, the slant angle ranges from about 30 degrees to about 85 degrees relative to the top surface 2 of dispenser 1. The length, depth, or height of shaft 4 is predicated on the thickness of dispenser 1 and typically ranges from about 0.1 to about 5 mm.
As human cells can range in diameter 4 from about 6 microns to more than about 50 microns, the shape of the shaft 4 holding such cells preferably should range from about 3 to about 25 microns on the low side and from about 9 microns to about 75 microns on the high side (or any value or subrange within the recited ranges, including endpoints) each being selected relative to the size of the cell and the angle of the truncated cone defining shaft 4; and
The cells selected should be able to roll across the surface of the dispenser 1.

Otherwise, the cells are added to dispenser 1 and subsequently into wells 21 of assay device 20 in a manner substantially similar to that of beads 11. In some cases, multiple copies of the same cell are desired to be added to a single well 21 of assay device 20. In such cases, a separate dispenser that may be structurally same as or similar to the dispenser 1 may be loaded with these cells with a single cell per dispenser 1. Additional cells are added to wells 21 of assay device 20 in a manner similar to the first addition of cells. Likewise, other assay components 10 may similarly be added.

### Systems

In one embodiment, there is provided a system for dispensing beads into an assay device. The system comprises:
a dispenser 1 comprising a multiplicity of shafts 4, wherein each of said shafts 4:
   comprises a variable cross-sectional width; and
   releasably contains only a single assay component (e.g., bead 11) having a width larger than a minimum cross-sectional width within a corresponding shaft; and
said dispenser 1 is fitted onto or over said assay device 20 such that each shaft 4 is aligned with a single well 21 on said assay device 20 such that upon release of said single assay component from said dispenser 1, only the single assay component is deposited into a single well 21; and
an assay device 20 comprising a multiplicity of wells 21.

The present invention is not to be limited by compositions, reagents, methods, systems, diagnostics, laboratory data, and the like, of the present disclosure. Also, the present invention is to not be limited by any preferred embodiments that are disclosed herein.

The subject matter described herein may be embodied in systems, apparatus, methods, and/or articles depending on the desired configuration. The embodiments set forth in the foregoing description do not represent all embodiments consistent with the subject matter described herein. Instead, they are merely some examples consistent with aspects related to the described subject matter. Although a few variations have been described in detail above, other modifications or additions are possible. In particular, further features and/or variations may be provided in addition to those set forth herein. For example, the embodiments described above may be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other embodiments may be within the scope of the following claims.

In addition, while a particular feature of the subject innovation may have been disclosed with respect to only one of several implementations, such feature may be combined with at least one other feature of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least one exemplary embodiment is described as using a plurality of units to perform the exemplary process, it is understood that the exemplary processes may also be performed by one or plurality of modules.

The use of the terms “first”, “second”, “third” and so on, herein, are provided to identify various structures, dimensions or operations, without describing any order, and the structures, dimensions or operations may be executed in a different order from the stated order unless a specific order is definitely specified in the context.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

1. A system for dispensing beads into an assay device, the system comprising:
an assay device comprising a multiplicity of wells; and
a dispenser comprising a multiplicity of shafts, wherein each of said shafts:
comprises a variable cross-sectional width; and
releasably contains a single assay component having a width larger than a minimum cross-sectional width within a corresponding shaft; and
said dispenser is fitted onto or over said assay device such that each shaft is aligned with a single well on said assay device such that upon release of said single assay component from said dispenser, only the single assay component is deposited into the single well.

2. The system of claim 1, wherein a first shaft of said shafts comprises a contour of a frustum or an hourglass.

3. The system of claim 1, wherein a first shaft of said shafts comprises a circular cross-section, and the cross-sectional width of the first shaft is indicative of a diameter of the circular cross-section.

4. The system of claim 1, wherein a first shaft of the shafts comprises a first portion at which a width decreases with respect to a height of the first shaft and a second portion at which a width increases with respect to a height of the first shaft.

5. The system of claim 1, wherein a first shaft of the shafts comprises a first portion having a first width and a second portion having a second width.

6. The system of claim 1, wherein a first shaft of said shafts comprises a portion in which a cross-sectional width decreases at a decreasing rate with respect to a height of the first shaft.

7. The system of claim 1, wherein a first shaft of said shafts comprises a portion in which a cross-sectional width decreases at an increasing rate with respect to a height of the first shaft.

8. The system of claim 1, further comprising a channel disposed underneath the shafts, the channel having a height of at least the minimum cross-sectional widths of the shafts and being configured to:
collect one or more second assay components that have second widths smaller than the minimum cross-sectional widths of the corresponding shafts through which the assay components pass; and
divert the second assay components to a second dispenser comprising a multiplicity of second shafts.

9. The system of claim 8, further comprising the second dispenser, wherein each of the second shafts:
comprises a second variable cross-sectional width, wherein a second minimum cross-sectional width of each of the second shafts is less than the minimum cross-sectional widths of the shafts; and
releasably contains a single second assay component having a second width larger than the second minimum cross-sectional width within a corresponding second shaft.

10. The system of claim 1, wherein the dispenser comprises an outlet through which one or more third assay components are diverted, the third assay components having third widths exceeding opening widths at openings of the corresponding shafts.

11. The system of claim 1, wherein the single assay component comprises a bead or a cell.

12. A dispenser comprising a multiplicity of shafts, wherein each of said shafts:
comprises a variable cross-sectional width; and
releasably contains a single assay component having a width larger than a minimum cross-sectional width within a corresponding shaft; and
said dispenser is fitted onto or over said assay device such that each shaft is aligned with a single well on said assay device such that upon release of said single assay component from said dispenser, only the single assay component is deposited into a single well.

13. The dispenser of claim 12, wherein a first shaft of said shafts comprises a contour of a frustum or an hourglass.

14. The dispenser of claim 12, wherein a first shaft of the shafts comprises a first portion at which a width decreases with respect to a height of the first shaft and a second portion at which a width increases with respect to a height of the first shaft.

15. The dispenser of claim 12, wherein a first shaft of said shafts comprises a circular cross-section, and the cross-sectional width of the first shaft is indicative of a diameter of the circular cross-section.

16. The dispenser of claim 12, wherein a first shaft of the shafts comprises a first portion having a first width and a second portion having a second width.

17. The dispenser of claim 12, wherein a first shaft of said shafts comprises a portion in which a cross-sectional width decreases at a decreasing rate with respect to a height of the first shaft.

18. The dispenser of claim 12, further comprising a channel disposed underneath the shafts, the channel having a height of at least the minimum cross-sectional widths of the shafts and being configured to:
collect one or more second assay components that have second widths smaller than the minimum cross-sectional widths of the corresponding shafts through which the assay components pass; and
divert the second assay components to a second dispenser comprising a multiplicity of second shafts.

19. The dispenser of claim 12, further comprising an outlet through which one or more third assay components are diverted, the third assay components having third widths exceeding opening widths at openings of the corresponding shafts.

20. The dispenser of claim 12, wherein the single assay component comprises a bead or a cell.

21. The system of claim 1, wherein a first shaft of the shafts comprises a first portion at which a cross-sectional width decreases with respect to a height of the first shaft and a second portion adjacent to the first portion, throughout which a cross-sectional width remains constant, and the assay component corresponding to the first shaft is secured to the first shaft at a boundary between the first portion and the second portion.

22. The system of claim 1, wherein the single assay components in each of the shafts have respective widths between a first threshold width and a second threshold width.

23. The system of claim 1, wherein the single assay components in each of the shafts have respective widths that are within a threshold range of a target width.

24. The system of claim 23, wherein the threshold range is ten percent of the target width.

25. The system of claim 22, wherein the dispenser further comprises one or more preliminary channels through which beads having widths smaller than the second threshold width pass while beads having widths larger than the second threshold widths are retained and diverted to a collector, the preliminary channels being disposed upstream of the shafts.

26. The system of claim 25, wherein the widths of the preliminary channels are constant throughout respective heights of the preliminary channels, or decreasing with respect to the heights of the preliminary channels.

27. The system of claim 25, wherein the widths comprise fourth widths of top openings of the preliminary channels and fifth widths of bottom openings of the preliminary channels, wherein the fourth widths are smaller than the fifth widths.

28. The system of claim 25, further comprising valves disposed at respective inlets and outlets of the preliminary channels.
